(19) United States
(12) Patent Application Publication
(10) Pub. No.: US 2007/0138266 A1
(43) Pub. Date: Jun. 21, 2007

(54) Reader/Writer Unit Of Automatic Vending Machine

(75) Inventors: Tomonobu Kameda, Isesaki-shi, Gumna (JP); Naoto Matsumoto, Isesaki-shi, Gumna (JP); Yasunari Nakajima, Isesaki-shi, Gumna (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Isesaki-shi (JP)

(21) Appl. No.: 11/612,079

(22) Filed: Dec. 18, 2006

(30) Foreign Application Priority Data
Dec. 20, 2005 (JP) 2005365966

(51) Int. Cl. G06F 7/08

(52) U.S. Cl. 235/381

(57) ABSTRACT

A pair of engagement members to be detachably engaged with a bill recognition device is provided on a unit body of a reader-writer unit, and the bill recognition device is attached to the unit body by engagement with the engagement members. Therefore, the bill recognition device can be attached/detached without using any screws. For example, when the bill recognition device is replaced, operations for detaching and attaching the bill recognition device can be performed advantageously easily. In the replacement process, the bill recognition device can be attached or detached while the unit body is in the state of being mounted on an outer door. Thus, the drawback of the unit body being dismounted from the outer door when the screws are removed as in the conventional art is eliminated and the attachment/detachment operations are not complicated.

### BACKGROUND OF THE INVENTION

1. Field of the Invention

The present invention relates to a reader/writer unit of an automatic vending machine through which an article can be purchased by using a card having an IC chip or a mobile phone.

2. Description of the Related Art

A reader/writer unit of this kind is so far known which has a unit body mounted inside an outer door of an automatic vending machine, a front cover portion provided in the unit body so as to project outside the outer door through a predetermined opening provided in the outer door, and a reader/writer provided in the front cover portion, and a bill recognition device is mounted on the back side of the unit body (see, for example, Japanese Patent Publication. 2001-126121).

In the automatic vending machine having this reader/writer unit, read of money information from a user's IC card and write of money information to the user's IC card by the reader/writer in the front cover portion are performed to enable a user to purchase an article without using cash. A bill can be used by being inserted in the bill recognition device through a bill insertion port provided in the reader/writer unit to purchase an article.

The bill recognition device is mounted on the outer door of the automatic vending machine together with the unit body of the above-described reader/writer unit by being screwed thereto. There is, therefore, a problem described below. When the bill recognition device is replaced or becomes unnecessary, an unscrewing operation is required for removal of the bill recognition device from the unit body. When the bill recognition device is unscrewed from the unit body, the unit body is also detached from the outer door. It is necessary to again screw the unit body to the outer door after removal of the bill recognition device. Thus, the process of attaching or detaching the bill recognition device is complicated.

### BRIEF SUMMARY OF THE INVENTION

In view of the above-described problem, an object of the present invention is to provide a reader/writer to which a bill recognition device can be easily attached without being screwed, and from which the bill recognition device can be easily detached.

To achieve the above-described object, according to the present invention, there is provided a reader/writer unit of an automatic vending machine including a unit body which is arranged so that a bill recognition device can be attached to the unit body on the back side of the same, and which is mounted inside an outer door of the automatic vending machine, a reader/writer which reads money information from an external storage medium and writes money information to the external storage medium, and a hollow cover portion which projects outward from the outer door through a predetermined opening provided in the outer door, wherein an engagement portion engageable with the bill recognition device is provided on the unit body and the bill recognition device can be attached to the unit body by engagement with the engagement portion.

According to the present invention, the bill recognition device is attached to the unit body by engagement with the engagement portion. Therefore, the bill recognition device can be attached/detached without using any screws. For example, when the bill recognition device is replaced, operations for detaching and attaching the bill recognition device can be performed very easily. In the replacement process, the bill recognition device can be attached or detached while the unit body is in the state of being mounted on an outer door. Thus, the drawback of the unit body being dismounted from the outer door when the screws are removed as in the conventional art is eliminated and advantageously, the attachment/detachment operations are not complicated.

These and other objects, features and advantages of the present invention will become apparent from the following detailed description with reference to the accompanying drawings.

### BRIEF DESCRIPTION OF SEVERAL VIEWS OF THE DRAWINGS

FIG. 1 is a front view of an automatic vending machine having a reader/writer unit which presents an embodiment of present invention;

FIG. 2 is a perspective view of the reader/writer unit and a bill recognition device;

FIG. 3 is a partially sectional side view of the reader/writer unit and the bill recognition device;

FIG. 4 is a block diagram of the reader/writer unit;

FIG. 5 is a partially sectional side view showing the process of attachment to an outer door;

FIG. 6 is a partially sectional side view showing a state of being attached to an outer door;

FIG. 7 is a partially sectional side view showing the process of attachment of the bill recognition device;

FIG. 8 is a partially sectional side view showing an attached state of the bill recognition device; and

FIG. 9 is a partially sectional side view showing a state in which a closing member is mounted.

### DETAILED DESCRIPTION OF THE INVENTION

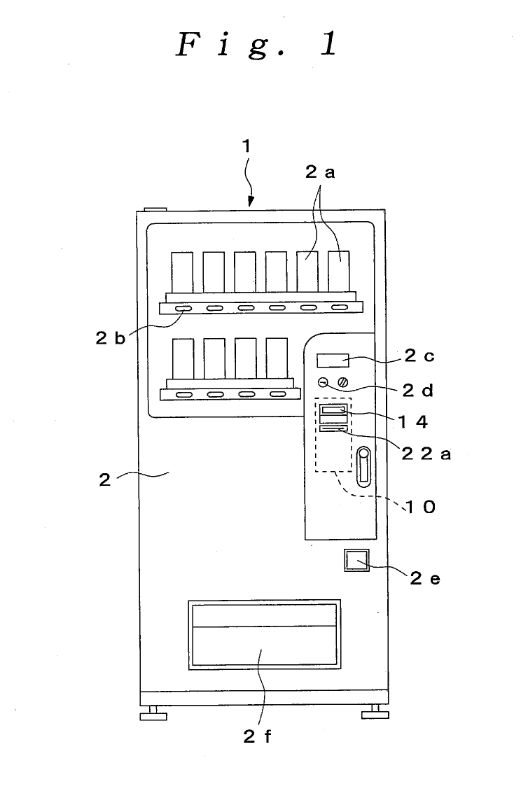

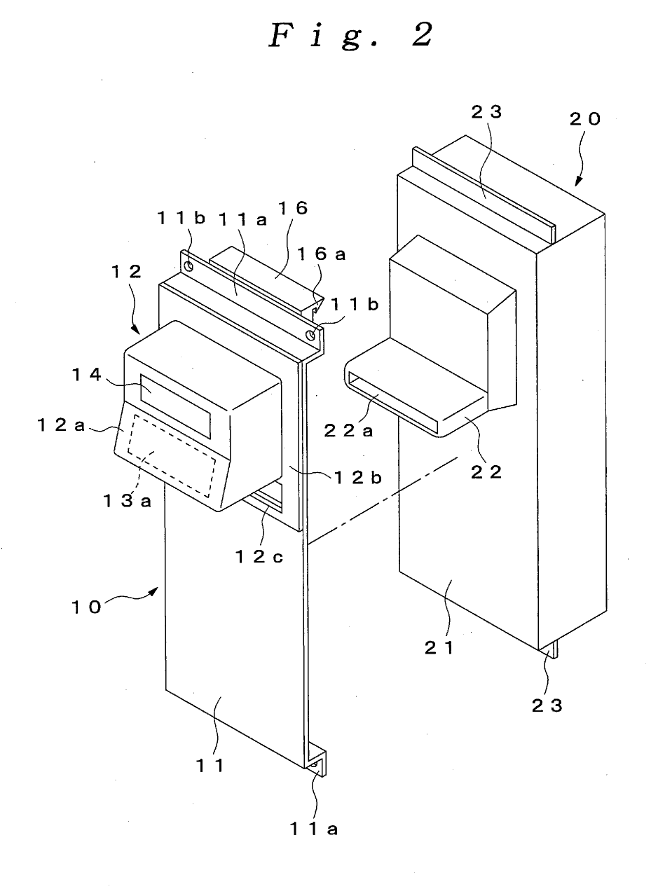

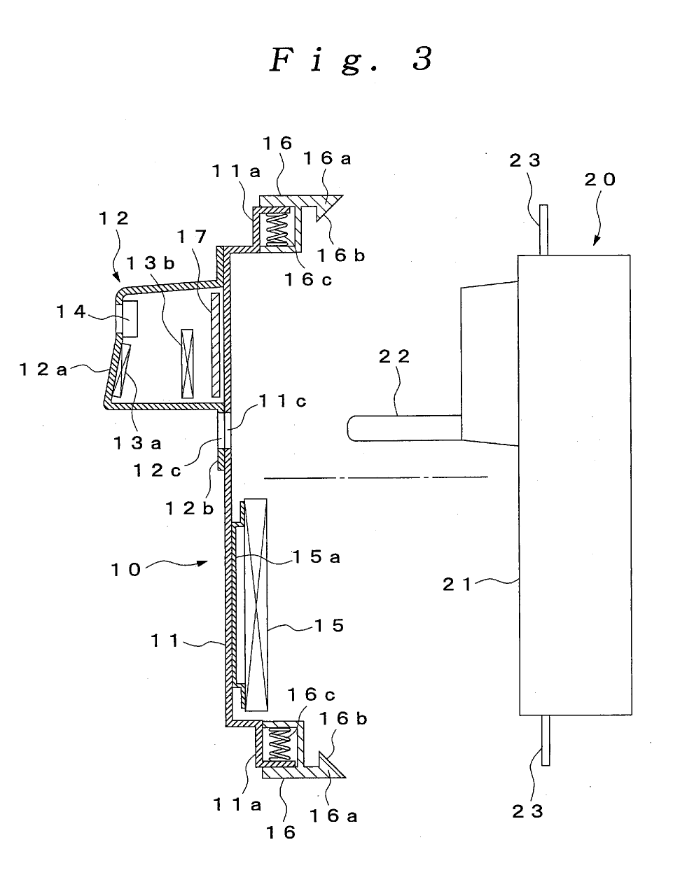

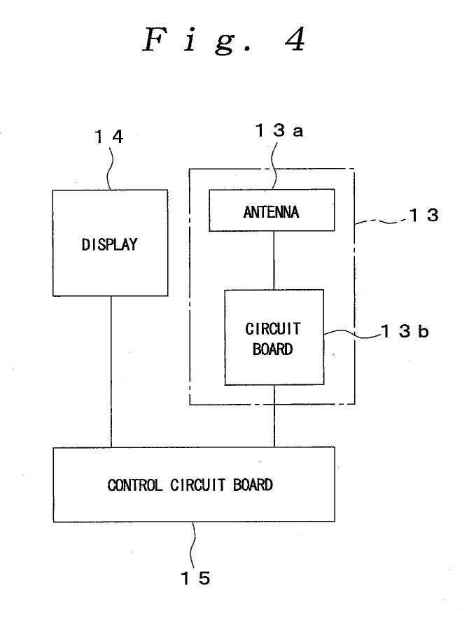

FIGS. 1 through 9 show an embodiment of the present invention. An automatic vending machine shown in FIGS. 1 through 9 has an automatic vending machine main body 1 having an opening at its front side, and an outer door 2 for opening/closing the front side of the automatic vending machine main body 1. Article samples 2a, an article selection switches 2b, an amount of money display 2c, a coin slot 2d, a coin return opening 2e and an article takeout opening 2f are provided in the outer door 2. In this automatic vending machine, articles are accommodated in article accommodation columns (not shown) provided in the automatic vending machine main body 1, and articles are each conveyed to the article takeout opening 2f in response to an operation on the corresponding article selection switch 2b.

The automatic vending machine also has a reader/writer unit 10 for performing read of money information from an IC card provided as an external storage medium and write of money information to the IC card and a bill recognition device 20 is detachably attached to the reader/writer unit 10. As a storage medium from or to which read/write of money information is performed, an IC chip mounted in a mobile phone may also be used.

The reader/writer unit 10 has a unit body 11 mounted inside the outer door 2, a front cover 12 attached to a front-side upper portion of the unit body 11, a reader/writer 13 provided in the front cover 12, a display 14 provided in the front cover 12, a control circuit board 15 for controlling the reader/writer 13 and the display 14, and a pair of upper and lower engagement members 16 to be detachably engaged with the bill recognition device 20.

The unit body 11 consists of a member in the form of a flat plate and is formed so as to be substantially equal in size to the front surface of the bill recognition device 20. Attachment projections 11a for attachment to the outer door 2 are provided at upper and lower ends of the unit body 11. Screw insertion holes 11b are formed in each attachment projection 11a at opposite ends in the width direction. An opening 11c through which a bill insertion portion of the bill recognition device 20 is passed is provided in the unit body 11.

The front cover 12 is formed of a hollow cover portion 12a opened at the back side, and a flange portion 12b formed around the back opening of the cover portion 12a. The cover portion 12a projects outward from the outer door 2 through an opening 2g provided in the outer door 2. A shielding member 17 for shielding against electromagnetic waves is provided in the front cover 12 at the back side of the same. The shielding member 17 is formed of a non-electroconductive member such as a magnetic material sheet or a ferrite sheet. An opening 12c through which the bill insertion portion 22 of the bill recognition device 20 is passed is provided in a lower flange portion in the flange portion 12b of the cover portion 12a. The opening 12c can be closed by a closing member 12d in the form of a lid detachably attached.

The reader/writer 13 is constituted by an antenna 13a provided in a front-side lower portion of the front cover 12 and a circuit board 13b which is connected to the antenna 13a, and which transmits data to the IC card through the antenna 13a and receives data from the IC card through the antenna 13a. In this case, the antenna 13a and the circuit board 13b are placed in front of the shielding member 17.

The display 14 is constituted by a well-known device for displaying predetermined character information on a liquid crystal display portion on the front side and attached to an upper portion of the front cover 12. That is, for example, a message for instructing a user in use of the IC card is displayed on the display 14.

The control circuit board 15 is mounted on a lower back surface portion of the unit body 11 by means of an attachment plate 15a and is connected to the reader/writer 13 and to the display 14. The control circuit board 15 is also connected to a main control unit (not shown) in the automatic vending machine and performs transmission and reception of money information with the main control unit.

Each engagement member 16 has an engagement portion 16a engageable with the bill recognition device 20 and a slanting surface 16b is provided at the extreme end side of each engagement portion 16a. Each engagement member 16 is attached to the attachment projection 11a of the unit body 11 so as to be movable in the vertical direction while being urged by a spring 16c in a direction for engagement with the bill recognition device 20.

The bill recognition device 20 has a device body 21 formed into the shape of a box and the bill insertion portion 22 extending frontward from the front side of the device body 21. The bill recognition device 20 is arranged in well-known manner to recognize a bill inserted through the bill insertion portion 22 and to contain the bill in the device body 21. Engagement projections 23 respectively engageable with the engagement members 16 of the reader/writer unit 10 are provided on the device body 21 so as to stand upright on upper and lower surfaces of the device body 21.

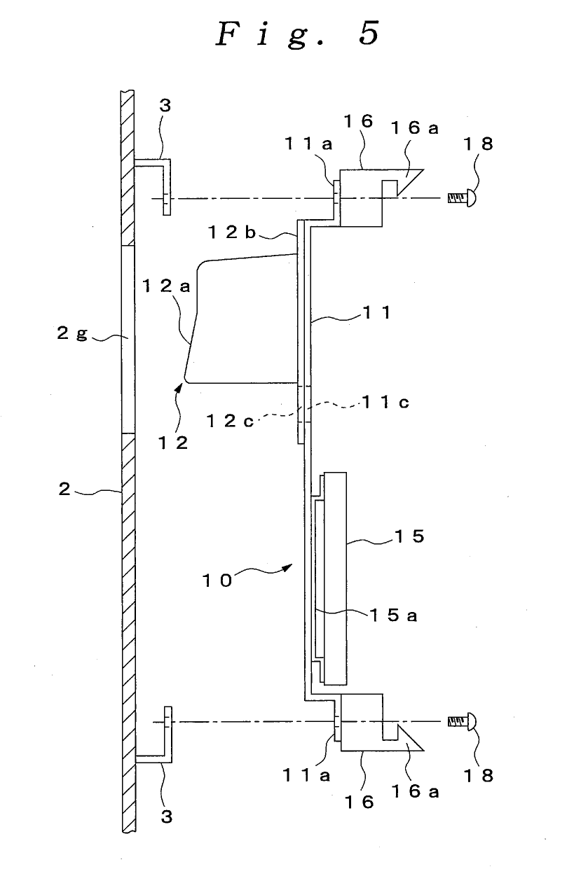

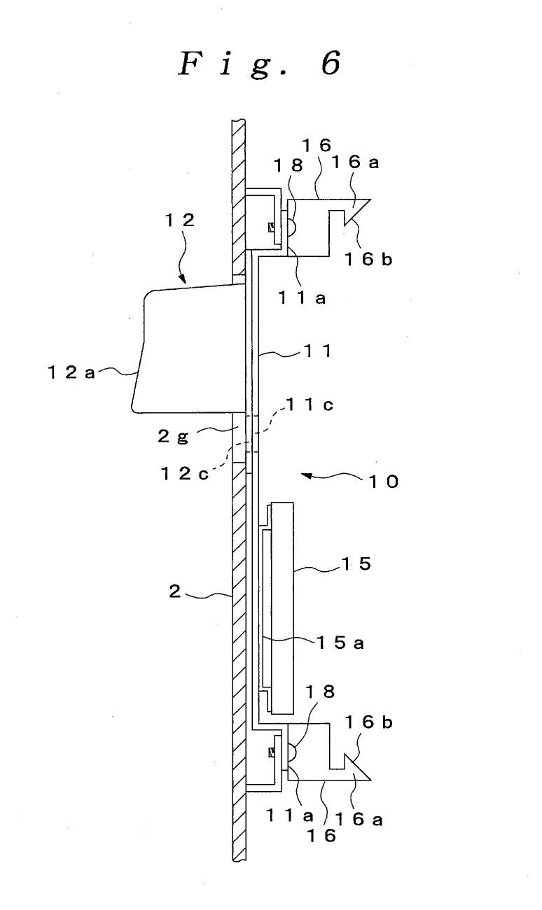

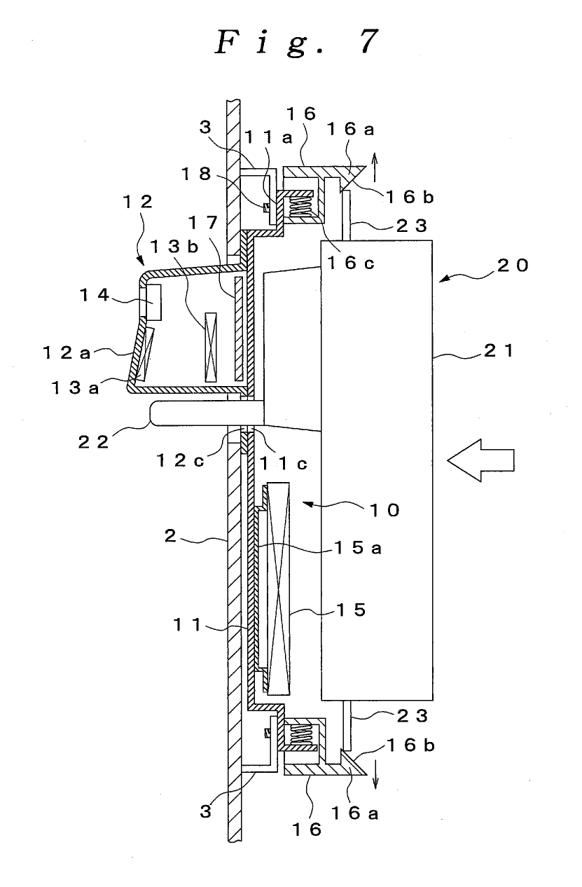

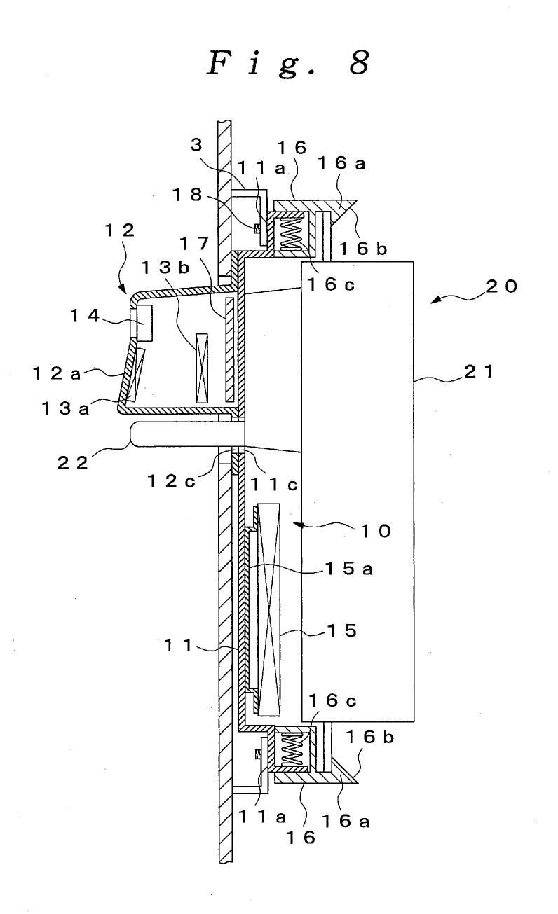

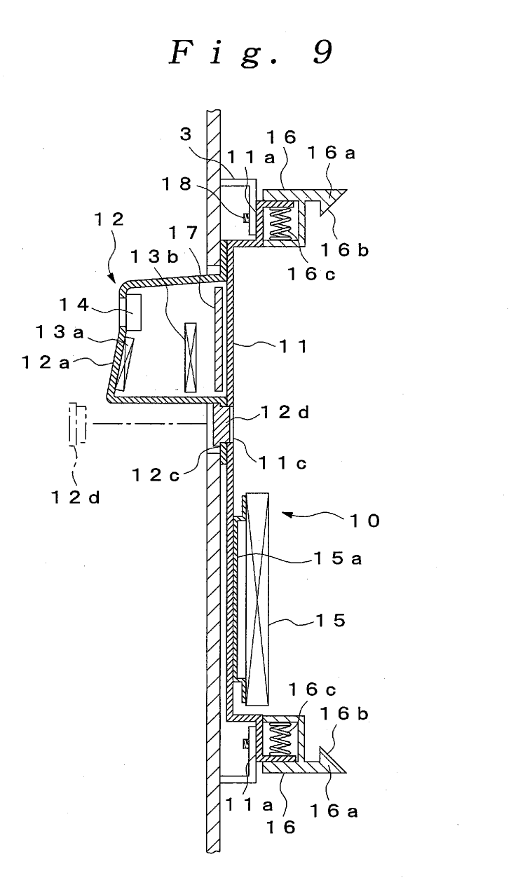

To mount the above-described reader/writer unit 10, the attachment projections 11a of the unit body 11 are fastened with screws 18 to attachment portions 3 provided on the back surface of the outer door 2, as shown in FIG. 5. The reader/writer unit 10 is thereby mounted inside the outer door 2, as shown in FIG. 6. At this time, the cover portions 12a of the front cover 12 projects outward through the opening 2g of the outer door 2. The bill recognition device 20 is attached on the back surface side of the reader/writer unit 10 mounted on the outer door 2, with the bill insertion portion 22 of the bill recognition device 20 projecting outward through the openings 11c and 12c of the reader/writer unit 10 and placed below the cover portion 12a. When the engagement projections 23 of the bill recognition device 20 are brought into contact with the engagement members 16 of the reader/writer unit 10 from the rear side, the engagement members 16 are moved in the direction for disengagement by the guiding action of the slanting surfaces 16b in contact with the engagement projections 23, as shown in FIG. 7. When the engagement projections 23 thereafter reach positions beyond the slanting surfaces 16b, the engagement members 16 are moved in the directions for engagement by the springs 16c to have the engagement portions 16a of the engagement members 16 engaged on the back sides of the engagement projections 23, as shown in FIG. 8. The bill recognition device 20 is thereby fixed on the reader/writer unit 10. When detaching the bill recognition device 20 from the reader/writer unit 10, the engagement projections 23 of the bill recognition device 20 are disengaged from the engagement portions 16a of the engagement members 16 while the engagement members 16 are moved in the direction opposite to the direction for engagement with finger tips for example. The bill recognition device 20 and the engagement members 16 are thereby disengaged from each other. If the bill recognition device 20 is not attached, the closing member 12d is mounted in the opening 12c of the reader/writer unit 10 to close the opening 12c with the closing member 12d, as shown in FIG. 9.

According to this embodiment, as described above, the pair of engagement members 16 to be detachably engaged with the bill recognition device 20 are provided on the unit body 11 of the reader/writer unit 10, and the bill recognition device 20 is attached to the unit body 11 by engagement with the engagement members 16, thus enabling attachment/detachment of the bill recognition device 20 without using any screws. For example, when the bill recognition device 20 is replaced, the operations for detaching and attaching the bill recognition device 20 can be performed very easily. In the replacement process, the bill recognition device 20 can be attached to or detached from the unit body 11 while the unit body 11 is in the state of being mounted on the outer door 2. Thus, the drawback of the unit body being dismounted from the outer door when the screws are removed as in the conventional art is eliminated and the detachment/attachment operations are not complicated.

The engagement members 16 are provided on the unit body 11 so as to be movable in the vertical direction and are urged by the springs 16c in the direction for engagement with the bill recognition device 20. Therefore, the operation to engage with the bill recognition device 20 can be performed by moving the engagement members 16 to ensure that the bill recognition device 20 is securely attached to the unit body 11.

The openings 11c and 12c for insertion of the bill insertion portion 22 of the bill recognition device 20 are further provided at a position below the cover portion 12a. Advantageously, therefore, the cover portion 12 can overhang the space above the bill insertion portion 22 to prevent rain water from falling directly on the bill insertion portion 22.

The closing member 12d capable of closing the opening 12c for insertion of the bill insertion portion 22 is detachably provided. Therefore, the opening 12c can be closed by the closing member 12d when the bill recognition device 20 is not attached, thus preventing intrusion of dust, rain water, foreign material and the like into the opening 12c with reliability.

The antenna 13a and the circuit board 13b of the reader/writer 13 are disposed inside the cover portion 12a of the front cover 12 to enable the length of wiring between the antenna 13a and the circuit board 13a to be reduced. External noise received by the wiring can be reduced thereby.

The shielding member 17 for shielding against electromagnetic waves is provided in the cover portion 12a at the back side to shield the reader/writer 13 from electromagnetic waves propagating from the bill recognition device 20 toward the reader/writer 13 in the cover portion 12a, thus reliably preventing transmission/reception failure between the IC card and reader/writer 13 due to electromagnetic waves.

The control circuit board 15 for control of the reader/writer 13 is mounted in the unit body 11. Therefore, the length of wiring between the reader/writer 13 and the control circuit board 15 can be shortened to reduce external noise received by the wiring.

In the above-described embodiment, the engagement members 16 engageable with the bill recognition device 20 are provided on the unit body 11 so as to be movable in the vertical direction. However, engagement portions elastically deformable in the direction for disengagement may alternatively be provided on the unit body 11.

The embodiment described in this specification is not limiting but only illustrative of the present invention. The scope of the invention is defined in the appended claims and all modifications falling within the meaning of the claims are included in the present invention.

1. A reader/writer unit of an automatic vending machine comprising a unit body which is arranged so that a bill recognition device can be attached to the unit body on the back side of the same, and which is mounted inside an outer door of the automatic vending machine; a reader/writer which reads money information from an external storage medium and writes money information to the external storage medium; and a hollow cover portion in which the reader/writer is arranged, and which projects outward from the outer door through a predetermined opening provided in the outer door,
wherein an engagement portion engageable with the bill recognition device is provided on the unit body and the bill recognition device is detachably mounted to the unit body by engagement with the engagement portion.

2. The reader/writer unit of the automatic venting machine according to claim 1, further comprising an engagement member having the engagement portion and provided on the unit body so as to be movable in a predetermined direction, and an urging member which urges the engagement member in a direction for engagement with the bill recognition device.

3. The reader/writer unit of the automatic vending machine according to claim 1, further comprising a bill insertion portion extending forward and providing an opening below the cover portion through which the bill insertion portion is passed.

4. The reader/writer unit of the automatic vending machine according to claim 3, further comprising a closing member capable of closing the opening for the bill insertion portion.

5. The reader/writer unit of the automatic vending machine according to claim 1, wherein a circuit board of the reader/writer is placed inside the cover portion.

6. The reader/writer unit of the automatic vending machine according to claim 1, wherein a shielding member for shielding against electromagnetic waves is provided in the cover portion at the back side of the same.

7. The reader/writer unit of the automatic vending machine according to claim 1, wherein a control circuit board for the reader/writer is mounted on the unit body.
